(19) United States
(12) Patent Application Publication
(10) Pub. No.: US 2005/0051144 A1
(43) Pub. Date: Mar. 10, 2005

(54) Device and process for facilitating the atomization of liquid fuels

(76) Inventors: Kenneth Stephen Champ, London (CA); Joseph Craig Archibald, London (CA)

Correspondence Address: PAUL GRANDUNETTI;LEVY & GRANDINETTI, 1725 K STREET, N.W., SUITE 408, WASHINGTON, D.C. 2006-1419, WA, 20006-1419, US

(21) Appl. No.: 10/835,603

(22) Filed: Apr. 30, 2004

Related U.S. Application Data
(60) Provisional application No. 60/467,147, filed on May 2, 2003.

(51) Int. Cl. F02M 27/04; B03C 1/02

(52) U.S. Cl. 123/538; 210/695; 210/222

(57) ABSTRACT

An electronic device used to emit a complex magnetic field is disclosed that will peak at a resonance point of liquid fuels. The device applies an electromagnetic pulse across a fuel flow line. The magnetic pulse allows the fuel to act at maximum efficiency and results in lower engine maintenance and in increased fuel savings. When connected around one or more fuel lines the device improves the combustion efficiency of hydrocarbon-based fuel systems and decreases their harmful emissions by treating the fuel at the entry point of the engine or combustion device.

This application claims priority to U.S. Provisional Application No. 60/467,147, which was filed on May 2, 2003.

### BACKGROUND OF THE INVENTION

1. Field of the Invention

The invention relates generally to reducing emissions and consumption of hydrocarbon based fuels without utilizing additives. Specifically, the invention relates to a device and a process for emitting a magnetic field that peaks at a resonance point of liquid fuels.

2. Description of Prior Art

Industry has searched for inexpensive devices or processes to improve fuel efficiency. The automotive industry in particular has pursued means for improving fuel efficiency in engines propelled by liquid fuels. Such engines are commonly internal combustion engines.

Numerous attempts to improve liquid fuel efficiency involved devices for better atomizing the fuel before it is sprayed into a combustion chamber. Many of these devices are nozzles and/or preheaters for the fuel.

The industry lacks an inexpensive device and process for facilitating the atomization of liquid fuels.

### SUMMARY OF THE INVENTION

The invention includes a device for facilitating atomization of a liquid fuel. The device has a means for applying an electromagnetic pulse across a fuel intake source. The means for applying the electromagnetic pulse is preferably set to approximately a resonance point of the liquid fuel.

The invention includes a process for facilitating atomization of a liquid fuel. Applying an electromagnetic field across a feed source for the liquid fuel is conducted. Tuning the electromagnetic pulse to approximately a resonance point for the liquid fuel is performed.

### BRIEF DESCRIPTION OF THE DRAWING

FIG. 1 is a schematic diagram of the preferred circuit for the invention.

### DETAILED DESCRIPTION OF THE INVENTION

The invention provides an electronic device which applies an electromagnetic pulse across a fuel flow line or supply source and thereby the fuel flowing through the line to an engine. The device emits a complex magnetic field. The magnetic field desirably is adapted to peak at an approximate resonance point of the liquid fuel.

The invention preferably uses a vehicle's battery and consumes less than three watts. The invention is desirably maintenance free and its performance does not degrade over time. The invention through both lab and field trials reduces harmful emissions by up to approximately 25 percent and fuel consumption by up to about 25 percent, but, generally, between 10 to 25 percent over the emissions of a stock engine operating under normal conditions. The reduction in emissions was demonstrated by emission testing at Ontario Drive Clean authorized centers with significant reduction in catalytic converter temperature. The reduction in fuel consumption was demonstrated while maintaining constant conditions when the fuel injector valves of a gasoline engine opening time frame was reduced with the invention. In addition, while using hundreds of tanks of gas/diesel fuel in a variety of test vehicles with and without the invention, it was clearly shown that an improvement in fuel economy resulted with the invention.

The device is believed to affect the size of the cluster of hydrocarbon molecules of a liquid fuel. The means for cluster disruption or “pulsing field” breaks the large clusters of hydrocarbon molecules down to smaller groupings allowing the fuel to burn more completely. Consequently, this cluster disruption causes fuels to generate more energy reducing harmful emissions and fuel consumption.

A fast rising magnetic pulse is only one component of the complex magnetic field. A magnetic field's amplitude desirably varies, for fuels used in common ground vehicles, at a 1.6 Hz frequency, and the period between pulses desirably varies from 0.14 milliseconds to 0.33 milliseconds. The set point for a particular fuel, such as fuels for jet engines, boilers, and furnaces, can be determined by one of ordinary skill in the art.

The complex magnetic field is preferably applied to the fuel via a coil wrapped around the fuel line. Other means for applying a magnetic field and/or an electronic pulse can be used. For example, a sonic pulse can be tuned to disrupt to the clusters of hydrocarbon fuel.

For best results, the fuel line is nonferrous and/or nonmagnetic, polarized, such as stainless steel, copper, plastic, etc. A means for generating the complex magnetic field is desirably connected to a power source such as a 12 volt DC power source for use in common vehicles. The present invention can be practiced using the following pulsating magnetic field, which can be created by a current flowing in a coil, when applied to the fuel line in a vehicle. The device clusters hydrocarbon-based fuels.

The invention is preferably a device that generates a magnetic field at or around a liquid fuel source that is sufficient to disrupt clusters of fuel molecules. The most desirable liquid fuels for use with this invention are liquids with liquid hydrocarbon fuels being the preferred fuels. The most commercially significant embodiments of the invention are use with gasoline, kerosene, and/or diesel fuel. However, the invention can be useful with gas fuels, such as methane, propane, hydrogen, and nonpetroleum-based fuels such as vegetable oils of many sources.

The preferred embodiment of the invention is used with gasoline or diesel engine vehicles. However, the invention is useful with other fuel consuming devices such as furnaces, boilers, turbine engines, space heaters, and torches.

The most desirable embodiments of the invention include one or more of the following parameters. These parameters are:
a. A fast rise time pulse with a frequency sweep between 3,000 and 7,000 Hz;
b. A 1.6 Hz square wave modulated on the carrier frequency which is sweeping between 3,000 and 7,000 Hz;
c. A microprocessor and/or operational amplifier oscillator to generate the frequencies;
d. A current amplifier that mixes and/or amplifies the frequencies to generate amplitudes of current between 1 and 20 Amperes; and
e. A duty cycle of the frequencies that varies between 10 percent and 50 percent depending on a fuel type and a unit of power rating.

When a fluid such as gasoline or diesel flows through a line and is subjected to a strong magnetic field by the invention, the fuel becomes polarized. Each molecule of the fuel is believed to experience a repelling magnetic force from other similarly polarized molecules. When the fuel is pushed through an injector into a combustion chamber, the fuel is vaporized. It is believed that, since the fuel is polarized, it breaks away further into individual molecules. The resonance pulsing of the device also causes the atoms to be excited, creating constant movement or additional kinetic energy. With a more complete breakdown of the liquid fuel, the fuel has a better reaction with oxygen or an oxidizer during the combustion stage and produces a better and cleaner burn. With improved efficiency achieved from the burning of the fuel, lower by-products or emissions like carbon monoxide, hydrocarbons, nitrous oxides, and other greenhouse gasses are produced from the burning of the fuel. The magnetizing and resonating effect on the fuel removes or reduces the size of impurities, which build up on fuel injection systems, to allow the injector to distribute the fuel properly into the combustion chamber.

The invention provides many advantages for an engine. These advantages can include: (a) improved idling, (b) higher efficiency, (c) less carbon build-up, (d) fewer emissions, (e) lower fuel consumption, (f) cooler catalytic converter, and (g) same engine temperature.

The invention works at all operating speeds. For example, an engine in a vehicle using the invention benefits with either city or highway driving. The invention uses little power from a power source such as a battery and does not drain or alter the lifespan of the battery.

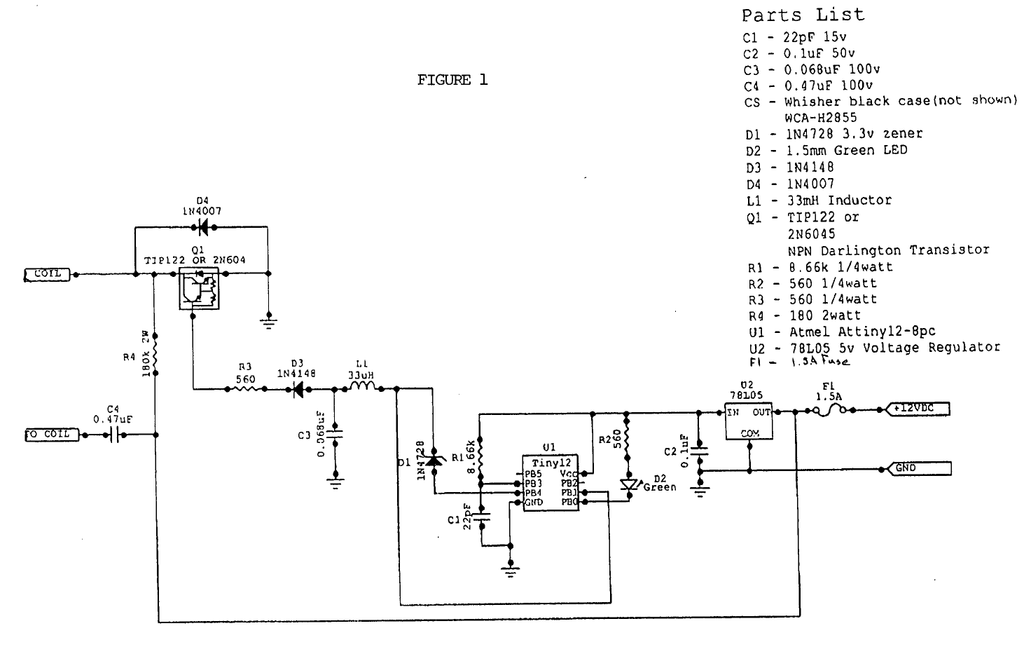

FIG. 1 illustrates a schematic of the preferred circuit for the invention. This embodiment is as follows.

DC power 10 enters the circuit and passes through fuse (F1) 11 for protection and stepped down to 5 Vdc using the 78L05 (U2) 12 to provide 5 Vdc to the microcontroller. The preferred microcontroller is a commercially available Atmel “ATTiny12” brand (U1) chip 13. Other microcontrollers can be programmed by those skilled in the art to operate within this circuit to generate a pulsing frequency as follows.

A frequency sweep on pin PB1 14 from a start frequency to an end frequency and back to start. Each frequency step is performed numerous times. The preferred code has the settings of a start frequency of 7 KHz, an end frequency of 4 KHz, and repetitions at each frequency step of 18.

After each completed cycle the LED (D2) 15 is connected to a PB0 16 and the zener diode (D1) 17 connected to PB4 switch states 18. If pin is logic 1, it is set to logic 0 and vice versa. This structure provides a cycling power indicator for the user to see functionality and to change the output level of the frequency sweep.

This signal passes through the LC Filter (L1/C3) 20 to remove harmonics with diode D3 21 to allow DC signals to pass for circuit protection. The signal then enters a Darlington pair transistor (A1) 22 to amplify the signal. A diode D4 23 is negative voltage spike protection. The amplified signal is now sent to the coil to perform the active work.

After each completed cycle the LED (D2) 15 connected to PB0 16 and the zener diode (D1) 17 connected to PB4 switch states 18, if pin is logic 1, it is set to logic 0 and vice versa. This configuration provides a cycling power indicator for the user to see functionality and change the output level of the frequency sweep.

This signal passes through the LC Filter (L1/C3) 20 to remove harmonics with diode (D3) 21 to allow DC signals to pass or provide circuit protection. The signal then enters the Darlington pair transistor (A1) 22 to amplify the signal. Diode (D4) 23 is a negative voltage spike protection. The amplified signal is now sent to the coil to perform the active work.

The preferred delay subroutine is as follows. The subroutine can be in many programming languages for a variety of controllers. Those having ordinary skill in the art can select appropriate controllers and program the controllers to an identical or equivalent operation as described below.

A routine is directed by the main program when it requires a delay. The main program loads the desired value of delay time into variable “t.” The routine copies “t” into variable “dly,” the routine then counts “dly” (dly=dly−1) down to zero and returns to a main program execution.

The RESET program is as follows. When power is initiated the code jumps to RESET to start the program execution. The RESET program initializes all pins on the Tiny12 (U1) chip 13. The RESET program then calls on a Delay program to wait for a time sufficient to allow voltages in the circuit to stabilize.

The MAIN program is as follows and is the main program loop. The MAIN program checks the state of PB0 16. If PB0 equals 0, the MAIN program turns on PB0 and sets PB4 26 to an output mode. This function turns on the LED (D2) 15 and enables the 3.3V zener (D1) 17 reference voltage and clamps the output signal to 3.3V.

If PB0 equals 1, the MAIN program turns off PB0 and sets PB4 26 to an input mode. This function turns off the LED (D2) 15 and removes the voltage reference point for the 3.3V zener (D1) 17, thus allowing the output signal to operate at 5V.

A Down Load variable “t” is used for the delay routine with the start value of $39 hex which equals 7 KHz output frequency.

A Load variable “c” is used with a value of $2d hex. This variable is the 45 frequency steps between 7 KHz and 4 KHz.

A D1 subroutine is set to increase variable “t” by 1 for delay values. Increasing “t” lowers the output frequency.

The Load variable “x” with $13 hex is the 18 steps of each frequency.

A D2 subroutine sets the output pin PB1 to logic 1. The the preferred microcontroller sets Call Delay, clears PB1 14, which is (set to logic 0, sets Call Delay, decreases “x” by 1 (x=x−1 to step down the counts at each frequency, sets Loop through D2 subroutine until “x” equals 0, decreases “c” by 1 (c=c−1, which steps to the next frequency, and sets Loop through the D1 subroutine until “c”=0. The microcontroller then sets Up to Load variable “t” for the delay routine with the start value of $67 hex which equals 4 KHz output frequency. The Load variable “c” is set with a value of $2d hex. This setting is the 45 frequency steps between 7 KHz and 4 KHz.

A U1 subroutine sets Decrease variable “t” by 1 for delay values. Decreasing “t” raises the output frequency. The Load variable “x” is set with $13 hex to provide the 18 steps of each frequency.

A U2 subroutine sets the output pin PB1 to logic 1, sets Call Delay, sets Clear PB1 to logic 0, sets Call Delay, decreases “x” by 1 (x=x−1, this steps down the counts at each frequency), sets Loop through the U2 subroutine until “x” equals 0, decreases “c” by 1 (c=c−1, this steps to the next frequency), sets Loop through the U1 subroutine until “c”=0. Then the microcontroller goes back to main and loop forever or until power is terminated.

### EXAMPLE 1

A 1992 Dodge 5.2L eight-cylinder Dakota truck was used as a test platform for the invention. The results are as follows.

The invention improved mileage by 15 to 18 percent over a test period of one and one-half years. The truck was driven over 20,000 kms in all four seasons. Prior to the installation of the engine enhancer a full tank of gasoline (87 octane) provided enough fuel to travel between 290 (cold weather driving) and 340 kms. After the installation of the engine enhancer the mileage per tank increased dramatically 350 and 390 kms respectively.

Vehicle engine was warmed a minimum of 15 minutes prior to each temperature test. The results of engine temperature were as follows.

TABLE 1

| | |
|---|---|
| Electromagnetic Pulse Off | Electromagnetic Pulse On |

Effects on Coolant (2,000 rpm)

| | |
|---|---|
| 204° F. | 204° F. |

Effects on Catalytic (800 rpm)

| | |
|---|---|
| 340° F. | 310° F. |

Effects on Catalytic (2,000 rpm)

| | |
|---|---|
| 574° F. | 476° F. |

The above data indicate that the invention is reducing emissions and not affecting the engine temperature.

TABLE 2
Effect on Pulse Width of Fuel Injectors
Pulse Width (2,000 rpm)

| | |
|---|---|
| Electromagnetic Pulse Off | Electromagnetic Pulse On |

| | |
|---|---|
| 2.0 mS | 1.8 mS |

The decrease in pulse width indicates less fuel is required to maintain the engine working at 2,000 rpm.

TABLE 3
Effects on RPM with Constant Pulse Width
RPM (Pulse Width 2.0 mS)

| Electromagnetic Pulse Off | Electromagnetic Pulse On |
|---|---|
| 2000 rpm | 2225 rpm |

The increase in revolutions per minute with a constant pulse width indicates that the engine is capable of performing additional work with the same amount of fuel.

TABLE 4
Effects on Emissions

| Emission Type | Electromagnetic Pulse Off | Electromagnetic Pulse On |
|---|---|---|
| HC ppm | 25 | 19 |
| CO percent | .02 | .01 |
| NO ppm | 1148 | 1061 |

The invention reduces the harmful emissions.

### EXAMPLE 2

A 1994 Oldsmobile 98 V 6 3.8 Lt was used as a test platform for the invention. The results are as follows.

Analyzing performance improvement using the invention. Under identical conditions (except for the use of the invention) the following data were recorded

TABLE 5
Summary of Results
Baseline Data

| Parameter | Data |
|---|---|
| Engine rpm | 1985 |
| TPS (V) | 0.68 |
| Air Flow (mg/Sec) | 12 |
| Base PW (mS) | 3.7 |
| Coolant Temperature F. | 217 |
| Cooling Fan Status | ON |

TABLE 6
Electromagnetic Pulse On/Installed

| Parameter | Data |
|---|---|
| Engine rpm | 2420 |
| TPS (V) | 0.68 |
| Air Flow (gm/Sec) | 14 |
| Base PW (mS) | 3.7 |
| Coolant Temperature F. | 215 |
| Cooling fan status | ON |

It was necessary for the vehicle's computer to relearn its idle settings after the invention was installed. This action was done by resetting the computer by disconnecting the computer's 12 volt feed.

A comparison of Tables 5 and 6 demonstrates the following.

The engine's revolution per minute increased from an average of 1985 to 2420 rpm. This figure amounts to a 21.9 percent increase.

The TPS or throttle position remained constant at 0.68 V.

The fuel injector pulse width a Base PW (ms) remained constant at 3.7 ms.

When the invention was started, the engine required an additional air flow (Airflow gm/Sec) of approximately 16 to 17 percent.

The engine temperature remained relatively constant between 215° and 217° F. Without the increase in air flow, conditioning the fuel does not produce additional work. The extra oxygen is necessary to react with the additional available fuel molecules. The computer sensors ensure that the engine does not overheat due to a lean fuel mixture. The test was repeated a number of times with similar results.

1. A device for facilitating atomization of a liquid fuel comprising:
a means for applying an electromagnetic pulse across a fuel intake source, the means for applying the electromagnetic pulse is set to approximately a resonance point of the liquid fuel.

2. A process for facilitating atomization of a liquid fuel comprising:
applying an electromagnetic field across a feed source for the liquid fuel; and
tuning the electromagnetic pulse to approximately a resonance point for the liquid fuel.
